(19) United States
(12) Patent Application Publication
(10) Pub. No.: US 2012/0063429 A1
(43) Pub. Date: Mar. 15, 2012

(54) METHODS AND APPARATUS OF FREQUENCY INTERLEAVING FOR 80 MHz TRANSMISSIONS

(75) Inventors: Lin Yang, San Diego, CA (US); Didier Johannes Richard Van Nee, De Meern (NL); Hemanth Sampath, San Diego, CA (US); Vincent Knowles Jones, IV, Redwood City, CA (US); Albert Van Zelst, Woerden (NL); Sameer Vermani, San Diego, CA (US)

(73) Assignee: QUALCOMM INCORPORATED, San Diego, CA (US)

(21) Appl. No.: 13/223,018

(22) Filed: Aug. 31, 2011

Related U.S. Application Data
(60) Provisional application No. 61/379,279, filed on Sep. 1, 2010.
(60) Provisional application No. 61/383,963, filed on Sep. 17, 2010.

(51) Int. Cl. H04W 92/00

(52) U.S. Cl. 370/338

(57) ABSTRACT

Certain aspects of the present disclosure provide techniques and apparatus for frequency interleaving for use with 80 MHz transmissions, such as those in the IEEE 802.11ac amendment to the IEEE 802.11 standard. According to certain aspects, frequency interleaving spatial streams for transmissions on channels having widths of about 80 MHz may comprise using an interleaving depth of 26. The number of frequency rotations may be 58 (or 29) for up to four (or up to eight) spatial streams. According to certain aspects, frequency interleaving up to eight (or up to four) spatial streams for transmission on channels having widths of about 80 MHz may comprise performing frequency rotation for each of the spatial streams based on a frequency rotation index=[0 4 2 6 1 5 3 7] (or=[0 2 1 3]).

### CROSS-REFERENCE TO RELATED APPLICATIONS

This application claims benefit of U.S. Provisional Patent Application Ser. No. 61/379,279, entitled “Methods and Apparatus of Frequency Interleaving for 80 MHz Transmissions” and filed Sep. 1, 2010, and U.S. Provisional Patent Application Ser. No. 61/383,963, entitled “Methods and Apparatus of Frequency Interleaving for 80 MHz Transmissions” and filed Sep. 17, 2010, both of which are herein incorporated by reference.

### BACKGROUND

1. Field

Certain aspects of the present disclosure generally relate to wireless communications and, more particularly, to frequency interleaving for 80 MHz transmissions.

2. Background

In order to address the issue of increasing bandwidth requirements demanded for wireless communications systems, different schemes are being developed to allow multiple user terminals to communicate with a single access point by sharing the channel resources while achieving high data throughputs. Multiple Input Multiple Output (MIMO) technology represents one such approach that has recently emerged as a popular technique for next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure generally relate to a frequency interleaver for 80 MHz transmissions.

Certain aspects of the present disclosure provide a method for wireless communications. The method generally includes frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to four spatial streams, and wherein a number of frequency rotations is 58; processing the interleaved spatial streams; and transmitting the processed spatial streams using the channels.

Certain aspects of the present disclosure provide an apparatus for wireless communications. The apparatus generally includes a processing system and a transmitter. The processing system is typically configured to frequency interleave one or more spatial streams for transmissions on one or more channels having widths of about 80 MHz, wherein the processing system is configured to frequency interleave the spatial streams by using an interleaving depth of 26 and by performing frequency rotation, wherein the one or more spatial streams comprise up to four spatial streams, and wherein a number of frequency rotations is 58; and to process the interleaved spatial streams. The transmitter is generally configured to transmit the processed spatial streams using the channels.

Certain aspects of the present disclosure provide an apparatus for wireless communications. The apparatus generally includes means for frequency interleaving one or more spatial streams for transmissions on one or more channels having widths of about 80 MHz, wherein the means for frequency interleaving is configured to use an interleaving depth of 26 and to perform frequency rotation, wherein the one or more spatial streams comprise up to four spatial streams, and wherein a number of frequency rotations is 58; means for processing the interleaved spatial streams; and means for transmitting the processed spatial streams using the channels.

Certain aspects of the present disclosure provide a computer-program product for wireless communications. The computer-program product generally includes a computer-readable medium having code for frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to four spatial streams, and wherein a number of frequency rotations is 58; for processing the interleaved spatial streams; and for transmitting the processed spatial streams using the channels.

Certain aspects of the present disclosure provide a method for wireless communications. The method generally includes frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to eight spatial streams, and wherein a number of frequency rotations is 29; processing the interleaved spatial streams; and transmitting the processed spatial streams using the channels.

Certain aspects of the present disclosure provide an apparatus for wireless communications. The apparatus generally includes a processing system and a transmitter. The processing system is typically configured to frequency interleave one or more spatial streams for transmissions on one or more channels having widths of about 80 MHz, wherein the processing system is configured to frequency interleave the spatial streams by using an interleaving depth of 26 and by performing frequency rotation, wherein the one or more spatial streams comprise up to eight spatial streams, and wherein a number of frequency rotations is 29; and to process the interleaved spatial streams. The transmitter is generally configured to transmit the processed spatial streams using the channels.

Certain aspects of the present disclosure provide an apparatus for wireless communications. The apparatus generally includes means for frequency interleaving one or more spatial streams for transmissions on one or more channels having widths of about 80 MHz, wherein the means for frequency interleaving is configured to use an interleaving depth of 26 and to perform frequency rotation, wherein the one or more spatial streams comprise up to eight spatial streams, and wherein a number of frequency rotations is 29; means for processing the interleaved spatial streams; and means for transmitting the processed spatial streams using the channels.

Certain aspects of the present disclosure provide a computer-program product for wireless communications. The computer-program product generally includes a computer-readable medium having code for frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to eight spatial streams, and wherein a number of frequency rotations is 29; for processing the interleaved spatial streams; and for transmitting the processed spatial streams using the channels.

Certain aspects of the present disclosure provide a method for wireless communications. The method generally includes receiving one or more signals on one or more channels having widths of about 80 MHz, processing the received signals to form one or more spatial streams, and frequency de-interleaving the spatial streams, wherein the frequency de-interleaving comprises using an interleaving depth of 26 and performing reverse frequency rotation, wherein the one or more spatial streams comprise up to four spatial streams, and wherein a number of reverse frequency rotations is 58.

Certain aspects of the present disclosure provide an apparatus for wireless communications. The apparatus generally includes a receiver configured to receive one or more signals on one or more channels having widths of about 80 MHz and a processing system configured to process the received signals to form one or more spatial streams and to frequency de-interleave the spatial streams, wherein the processing system is configured to frequency de-interleave the spatial streams by using an interleaving depth of 26 and by performing reverse frequency rotation, wherein the one or more spatial streams comprise up to four spatial streams, and wherein the number of reverse frequency rotations is 58.

Certain aspects of the present disclosure provide an apparatus for wireless communications. The apparatus generally includes means for receiving one or more signals on one or more channels having widths of about 80 MHz, means for processing the received signals to form one or more spatial streams, and means for frequency de-interleaving the spatial streams, wherein the means for frequency de-interleaving is configured to use an interleaving depth of 26 and to perform reverse frequency rotation, wherein the one or more spatial streams comprise up to four spatial streams, and wherein the number of reverse frequency rotations is 58.

Certain aspects of the present disclosure provide a computer-program product for wireless communications. The computer-program product generally includes a computer-readable medium having code for receiving one or more signals on one or more channels having widths of about 80 MHz, for processing the received signals to form one or more spatial streams, and for frequency de-interleaving the spatial streams, wherein the frequency de-interleaving comprises using an interleaving depth of 26 and performing reverse frequency rotation, wherein the one or more spatial streams comprise up to four spatial streams, and wherein a number of reverse frequency rotations is 58.

Certain aspects of the present disclosure provide a method for wireless communications. The method generally includes receiving one or more signals on one or more channels having widths of about 80 MHz, processing the received signals to form one or more spatial streams, and frequency de-interleaving the spatial streams, wherein the frequency de-interleaving comprises using an interleaving depth of 26 and performing reverse frequency rotation, wherein the one or more spatial streams comprise up to eight spatial streams, and wherein a number of reverse frequency rotations is 29.

Certain aspects of the present disclosure provide an apparatus for wireless communications. The apparatus generally includes a receiver configured to receive one or more signals on one or more channels having widths of about 80 MHz and a processing system configured to process the received signals to form one or more spatial streams and to frequency de-interleave the spatial streams, wherein the processing system is configured to frequency de-interleave the spatial streams by using an interleaving depth of 26 and by performing reverse frequency rotation, wherein the one or more spatial streams comprise up to eight spatial streams, and wherein the number of reverse frequency rotations is 29.

Certain aspects of the present disclosure provide an apparatus for wireless communications. The apparatus generally includes means for receiving one or more signals on one or more channels having widths of about 80 MHz, means for processing the received signals to form one or more spatial streams, and means for frequency de-interleaving the spatial streams, wherein the means for frequency de-interleaving is configured to use an interleaving depth of 26 and to perform reverse frequency rotation, wherein the one or more spatial streams comprise up to eight spatial streams, and wherein the number of reverse frequency rotations is 29.

Certain aspects of the present disclosure provide a computer-program product for wireless communications. The computer-program product generally includes a computer-readable medium having code for receiving one or more signals on one or more channels having widths of about 80 MHz, for processing the received signals to form one or more spatial streams, and for frequency de-interleaving the spatial streams, wherein the frequency de-interleaving comprises using an interleaving depth of 26 and performing reverse frequency rotation, wherein the one or more spatial streams comprise up to eight spatial streams, and wherein a number of reverse frequency rotations is 29.

Certain aspects of the present disclosure provide a method for wireless communications. The method generally includes frequency interleaving up to eight spatial streams for transmission on channels having widths of about 80 MHz, wherein the frequency interleaving comprises performing frequency rotation for each of the spatial streams based on a frequency rotation index=[0 4 2 6 1 5 3 7]; processing the interleaved spatial streams; and transmitting the processed spatial streams using the channels.

Certain aspects of the present disclosure provide an apparatus for wireless communications. The apparatus generally includes a processing system and a transmitter. The processing system is typically configured to frequency interleave up to eight spatial streams for transmission on channels having widths of about 80 MHz, wherein the processing system is configured to frequency interleave the spatial streams by performing frequency rotation for each of the spatial streams based on a frequency rotation index=[0 4 2 6 1 5 3 7]; and to process the interleaved spatial streams. The transmitter is generally configured to transmit the processed spatial streams using the channels.

Certain aspects of the present disclosure provide an apparatus for wireless communications. The apparatus generally includes means for frequency interleaving up to eight spatial streams for transmissions on channels having widths of about 80 MHz, wherein the means for frequency interleaving is configured to perform frequency rotation for each of the spatial streams based on a frequency rotation index=[0 4 2 6 1 5 3 7]; means for processing the interleaved spatial streams; and means for transmitting the processed spatial streams using the channels.

Certain aspects of the present disclosure provide a computer-program product for wireless communications. The computer-program product generally includes a computer-readable medium having code for frequency interleaving up to eight spatial streams for transmissions on channels having widths of about 80 MHz, wherein the frequency interleaving comprises performing frequency rotation for each of the spatial streams based on a frequency rotation index=[0 4 2 6 1 5 3 7]; for processing the interleaved spatial streams; and for transmitting the processed spatial streams using the channels.

Certain aspects of the present disclosure provide a method for wireless communications. The method generally includes frequency interleaving up to four spatial streams for transmission on channels having widths of about 80 MHz, wherein the frequency interleaving comprises performing frequency rotation for each of the spatial streams based on a frequency rotation index=[0 2 1 3]; processing the interleaved spatial streams; and transmitting the processed spatial streams using the channels.

Certain aspects of the present disclosure provide an apparatus for wireless communications. The apparatus generally includes a processing system and a transmitter. The processing system is typically configured to frequency interleave up to four spatial streams for transmission on channels having widths of about 80 MHz, wherein the processing system is configured to frequency interleave the spatial streams by performing frequency rotation for each of the spatial streams based on a frequency rotation index=[0 2 1 3]; and to process the interleaved spatial streams. The transmitter is generally configured to transmit the processed spatial streams using the channels.

Certain aspects of the present disclosure provide an apparatus for wireless communications. The apparatus generally includes means for frequency interleaving up to four spatial streams for transmissions on channels having widths of about 80 MHz, wherein the means for frequency interleaving is configured to perform frequency rotation for each of the spatial streams based on a frequency rotation index=[0 2 1 3]; means for processing the interleaved spatial streams; and means for transmitting the processed spatial streams using the channels.

Certain aspects of the present disclosure provide a computer-program product for wireless communications. The computer-program product generally includes a computer-readable medium having code for frequency interleaving up to four spatial streams for transmissions on channels having widths of about 80 MHz, wherein the frequency interleaving comprises performing frequency rotation for each of the spatial streams based on a frequency rotation index=[0 2 1 3]; for processing the interleaved spatial streams; and for transmitting the processed spatial streams using the channels.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates a transmit (TX) data processor at a transmitting entity, in accordance with certain aspects of the present disclosure.

FIG. 5 illustrates example operations that may be performed at a transmitting entity, such as an access point (AP), to frequency interleave spatial streams for transmissions on channels having widths of about 80 MHz, in accordance with certain aspects of the present disclosure.

FIG. 5A illustrates example means capable of performing the operations shown in FIG. 5.

FIG. 6 is an example graph of packet error rate (PER) versus signal-to-noise ratio (SNR) in decibels (dB) for three different interleaving depths on an 80 MHz channel using a single spatial stream, 16-QAM (quadrature amplitude modulation with 16 modulation states), and a code rate of ½, in accordance with certain aspects of the present disclosure.

FIG. 7 is an example graph of PER versus SNR in dB for three different interleaving depths on an 80 MHz channel using four spatial streams, 256-QAM (QAM with 256 modulation states), and a code rate of ¾, in accordance with certain aspects of the present disclosure.

FIG. 8 is an example graph of PER versus SNR in dB for three different interleaving depths on an 80 MHz channel using eight spatial streams, 64-QAM (QAM with 64 modulation states), and a code rate of %, in accordance with certain aspects of the present disclosure.

FIG. 9 is a table comparing relative SNR differences at a PER of 1% achieved with three different interleaving depths for various modulation and coding schemes (MCSs) and for different numbers of spatial streams, in accordance with certain aspects of the present disclosure.

FIG. 10 illustrates a receive (RX) data processor at a receiving entity, in accordance with certain aspects of the present disclosure.

FIG. 11 illustrates example operations that may be performed at a receiving entity, such as a user terminal, to frequency de-interleave spatial streams processed from signals received on channels having widths of about 80 MHz, in accordance with certain aspects of the present disclosure.

FIG. 11A illustrates example means capable of performing the operations shown in FIG. 11.

FIG. 12 illustrates example operations that may be performed at a transmitting entity, such as an AP, to frequency interleave up to eight spatial streams for transmissions on channels having widths of about 80 MHz, in accordance with certain aspects of the present disclosure.

FIG. 12A illustrates example means capable of performing the operations shown in FIG. 12.

FIG. 13 illustrates example operations that may be performed at a transmitting entity, such as an AP, to frequency interleave up to four spatial streams for transmissions on channels having widths of about 80 MHz, in accordance with certain aspects of the present disclosure.

FIG. 13A illustrates example means capable of performing the operations shown in FIG. 13.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### AN EXAMPLE WIRELESS COMMUNICATION SYSTEM

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to a different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station (MS), a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

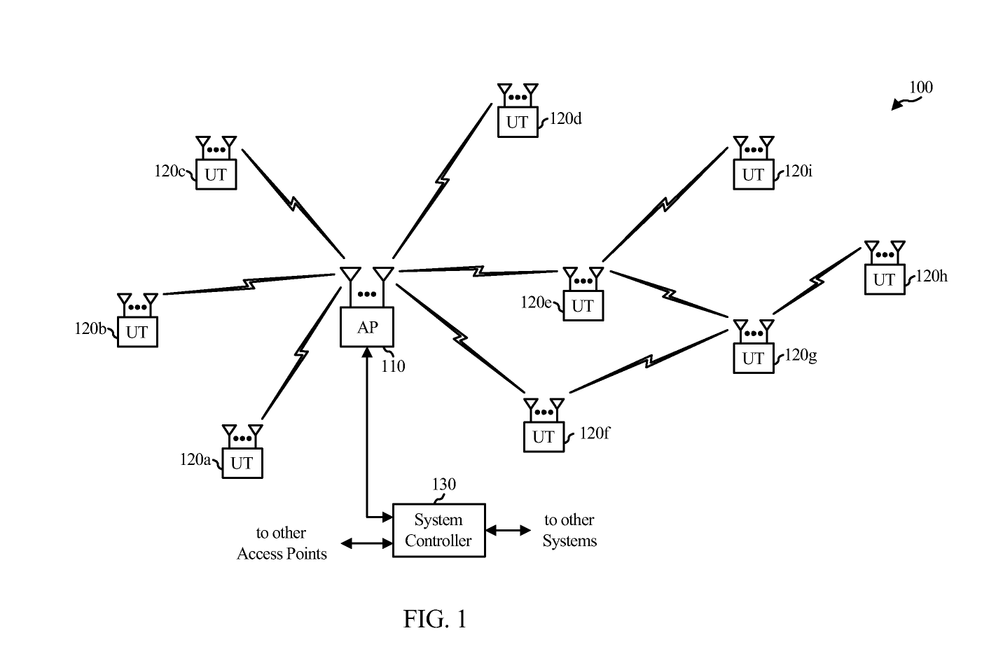

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≦K≦1 if the data symbol streams for the K user terminals are not multiplexed in code, frequency or time by some means. K may be greater than Nₐₚ if the data symbol streams can be multiplexed using TDMA techniques, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≦1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

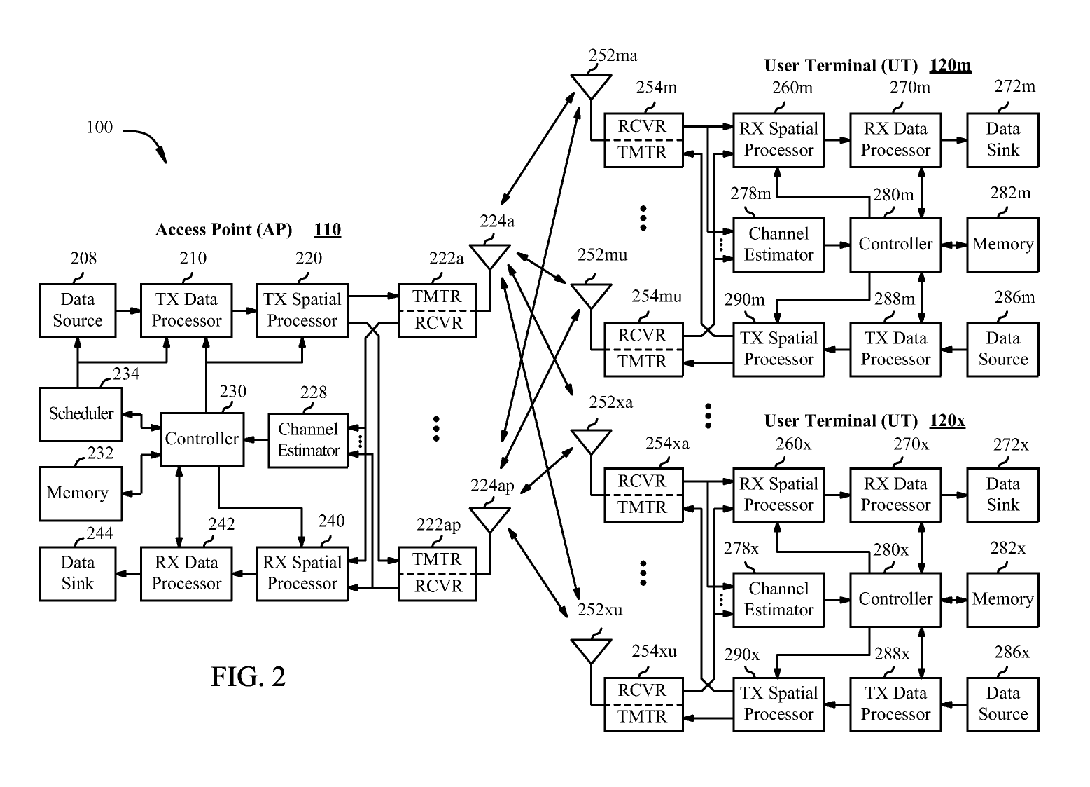

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, de-interleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, de-interleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

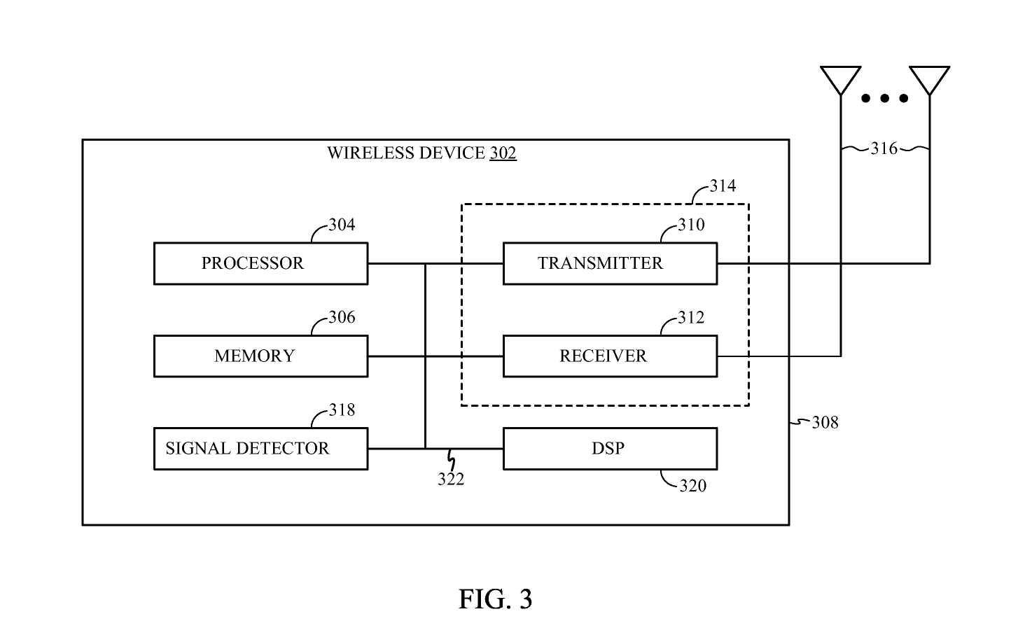

FIG. 3 illustrates various components that may be utilized in a wireless device 302 that may be employed within a wireless communication system (e.g., system 100 of FIG. 1). The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

The system 100 illustrated in FIG. 1 may operate in accordance with the IEEE 802.11ac wireless communications standard. The IEEE 802.11ac standard represents an IEEE 802.11 amendment that allows for higher throughput in IEEE 802.11 wireless networks. The higher throughput may be realized through several measures such as parallel transmissions to multiple stations (STAs) at once, or by using a wider channel bandwidth (e.g., 80 MHz or 160 MHz). The IEEE 802.11ac standard is also referred to as the Very High Throughput (VHT) wireless communications standard.

### EXAMPLE FREQUENCY INTERLEAVING FOR 80 MHZ TRANSMISSIONS

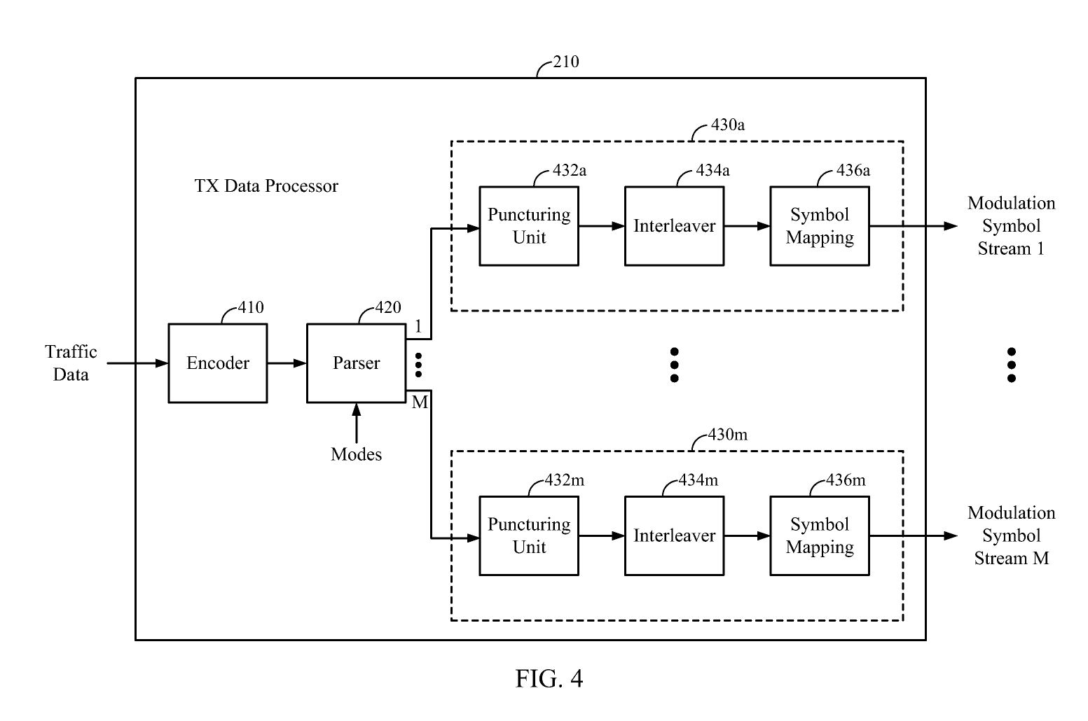

FIG. 4 is a block diagram of the TX data processor 210 at access point 110 for certain aspects. Within the TX data processor 210, an encoder 410 may encode traffic data in accordance with an encoding scheme and generate code bits. The encoding scheme may include a convolutional code, a Turbo code, a low density parity check (LDPC) code, a cyclic redundancy check (CRC) code, a block code, and so on, or a combination thereof. For certain aspects, the encoder 410 may implement a rate ½ binary convolutional encoder that generates two code bits for each data bit. A parser 420 may receive the code bits from the encoder 410 and parse the code bits into M streams, as described below.

M stream processors 430a through 430m may receive the M streams of code bits from the parser 420. Each stream processor 430 may include a puncturing unit 432, an interleaver 434 (also known as a frequency interleaver), and a symbol mapping unit 436. The puncturing unit 432 may puncture (or delete) as many code bits in its stream as necessary to achieve the desired code rate for the stream. For example, if the encoder 410 is a rate ½ convolutional encoder, then code rates greater than ½ may be obtained by deleting some of the code bits from the encoder 410. The interleaver 434 may interleave (or reorder) the code bits from the puncturing unit 432 based on an interleaving scheme. Interleaving provides time, frequency, and/or spatial diversity for the code bits. The symbol mapping unit 436 may map the interleaved bits in accordance with a modulation scheme and may provide modulation symbols. The symbol mapping may be achieved by (1) grouping sets of B bits to form B-bit values, where B≧1, and (2) mapping each B-bit value to a point in a signal constellation corresponding to the modulation scheme. Each mapped signal point is a complex value and corresponds to a modulation symbol. M stream processors 430a through 430m may provide M streams of modulation symbols to the TX spatial processor 220. The encoding, parsing, puncturing, interleaving, and symbol mapping may be performed based on control signals provided by the controller 230.

System 100 may support a set of modes for data transmission. Each mode (also known as a modulation and coding scheme (MCS)) is associated with a particular data rate or spectral efficiency, a particular code rate, and a particular modulation scheme. Example modulation schemes used by the symbol mapping unit 436 may include binary phase shift keying (BPSK), quadrature phase shift keying (QPSK), and quadrature amplitude modulation (QAM). The data rate for each mode is determined by the code rate and the modulation scheme for that mode and may be given in units of data bits per modulation symbol.

Various suitable code rates may be used for modes supported by system 100. Each code rate higher than rate ½ may be obtained by puncturing some of the rate-½ code bits from encoder 410 based on a specific puncture pattern. As an example, Table 1 lists exemplary puncture patterns for seven different code rates for a particular constraint length k=7 convolutional code. These puncture patterns provide good performance for this convolutional code and are identified based on computer simulation. Other puncture patterns may also be used for the supported code rates for this convolutional code and also for other convolutional codes of the same or different constraint length.

TABLE 1

| Code Rate | Puncture pattern | # Input Bits | # Output Bits |
|---|---|---|---|
| 1/2 | 11 | 2 | 2 |
| 7/12 | 11111110111110 | 14 | 12 |
| 5/8 | 1110111011 | 10 | 8 |
| 2/3 | 1110 | 4 | 3 |
| 3/4 | 111001 | 6 | 4 |
| 5/6 | 1110011001 | 10 | 6 |
| 7/8 | 11101010011001 | 14 | 8 |

For an m/n code rate, there are n code bits for every m data bits. A rate ½ convolutional encoder may generate 2 m code bits for every m data bits. To obtain the code rate of m/n, the puncturing unit 432 may output n code bits for each set of 2 m code bits from the encoder 410. Thus, the puncturing unit 432 may delete 2 m-n code bits from each set of 2 m code bits from the encoder 410 to obtain the n code bits for code rate m/n. The code bits to be deleted from each set are denoted by the zeros (‘0’) in the puncture pattern. For example, to obtain a code rate of 7/12, two code bits are deleted from each set of 14 code bits from the encoder 410, with the deleted bits being the 8-th and 14-th bits in the set, as denoted by the puncture pattern ‘11111110111110’. No puncturing is performed if the desired code rate is ½.

The mode selected for each stream determines the code rate for that stream, which in turn determines the puncture pattern for the stream. If different modes may be selected for different streams, then up to M different puncture patterns may be used for the M streams.

In the interleaver 434, coded, parsed, and punctured bits may be frequency interleaved. The bits may be interleaved by a separate block interleaver for each spatial stream with a particular block size (also known as an interleaving depth (I_{D}) or a number of columns (N_{COL})). For each spatial stream processed, the interleaver 434 may perform three stages of interleaving. The first two stages may involve permutation operations, while the third stage may perform a frequency rotation operation (e.g., bit circulation). The first permutation operation may ensure that adjacent coded bits are mapped onto nonadjacent subcarriers. The second permutation operation may ensure that coded bits are mapped alternately onto less and more significant bits of the constellation in an effort to break the frequency correlation between successive coded bits and to avoid long runs of low reliability bits (e.g., LSBs). In the frequency rotation operation, the base subcarrier rotation (i.e., the frequency rotation amount) may be designated as D or Nᵣₒₜ. For certain aspects, frequency rotation may only be performed in the case of more than one spatial stream (M>1).

For IEEE 802.11a, the block size for the interleaver 434 corresponded to the number of bits in a single OFDM symbol. To support IEEE 802.11n, the block interleavers may be based on the 802.11a interleaver with certain modifications to support multiple spatial streams and 40 MHz transmissions. However, to support channel widths of up to 80 MHz according to IEEE 802.11ac, the block size in the block interleaver for the frequency interleaver may not be large enough.

Accordingly, what is needed are techniques and apparatus to support frequency interleaving for 80 MHz transmissions.

Channel widths of 80 MHz may include about 234 data tones according to IEEE 802.11ac. Therefore, possible interleaving depths may comprise 13, 18, 26, or 39. The interleaving depth yielding the best performance (in terms of lowest signal-to-noise ratio (SNR) at a given packet-error rate (PER)) may depend on the modulation and code scheme (MCS) and the number of spatial streams, for example. However, a single interleaving depth for 80 MHz transmissions suitable for all modulation schemes, code rates, and numbers of spatial streams would be ideal.

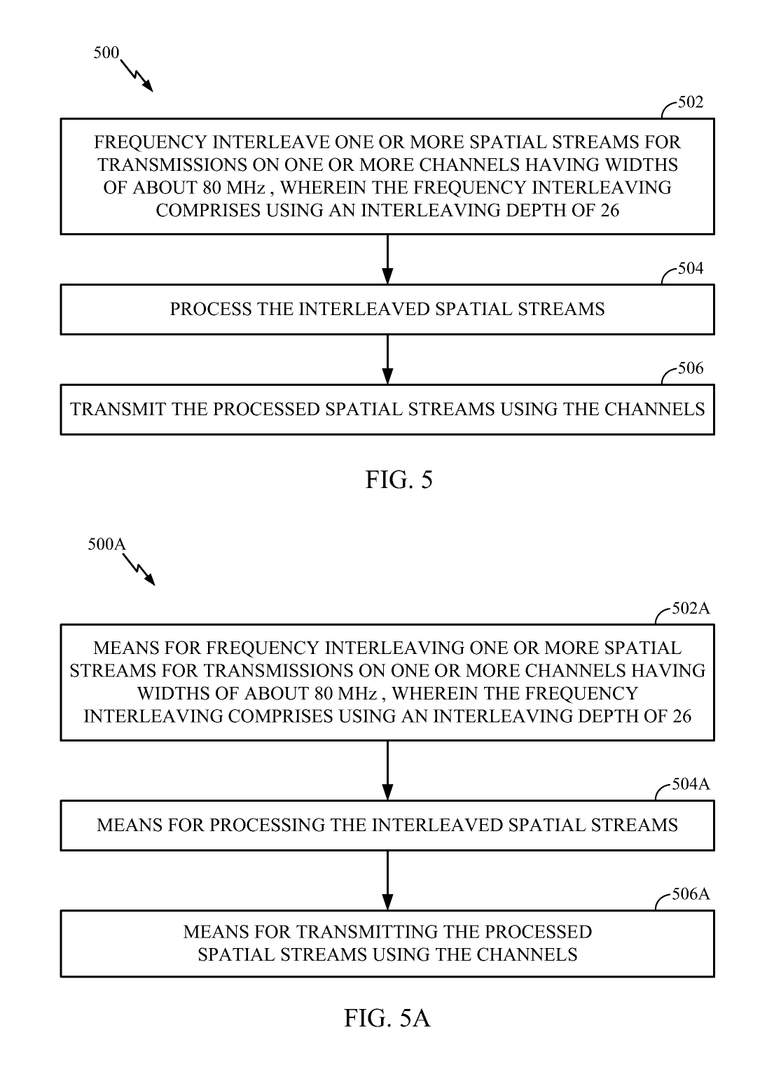

FIG. 5 illustrates example operations 500 that may be performed at a transmitting entity, such as an access point (AP) or a user terminal, to frequency interleave spatial streams for transmissions on channels having widths of about 80 MHz. The operations 500 may begin, at 502, by frequency-interleaving one or more spatial streams for transmission on one or more channels having widths of about 80 MHz, wherein the frequency interleaving comprises using an interleaving depth of 26. For certain aspects, the interleaving depth of 26 may be used for all MCSs supported by IEEE 802.11ac or a subsequent amendment to the IEEE 802.11 standard. For certain aspects, the interleaving depth of 26 may be used for all numbers of spatial streams supported by IEEE 802.11ac or a subsequent amendment.

At 504, the transmitting entity may process the interleaved spatial streams. This processing may include symbol mapping, performing an inverse Fourier transform to convert the mapped spatial streams to the time domain, converting the time domain streams to the analog domain using a digital-to-analog converter, and performing radio frequency (RF) processing on the analog signals (e.g., upconverting the baseband signals). At 506, the transmitting entity may transmit the processed spatial streams via one or more antennas using the 80 MHz channels.

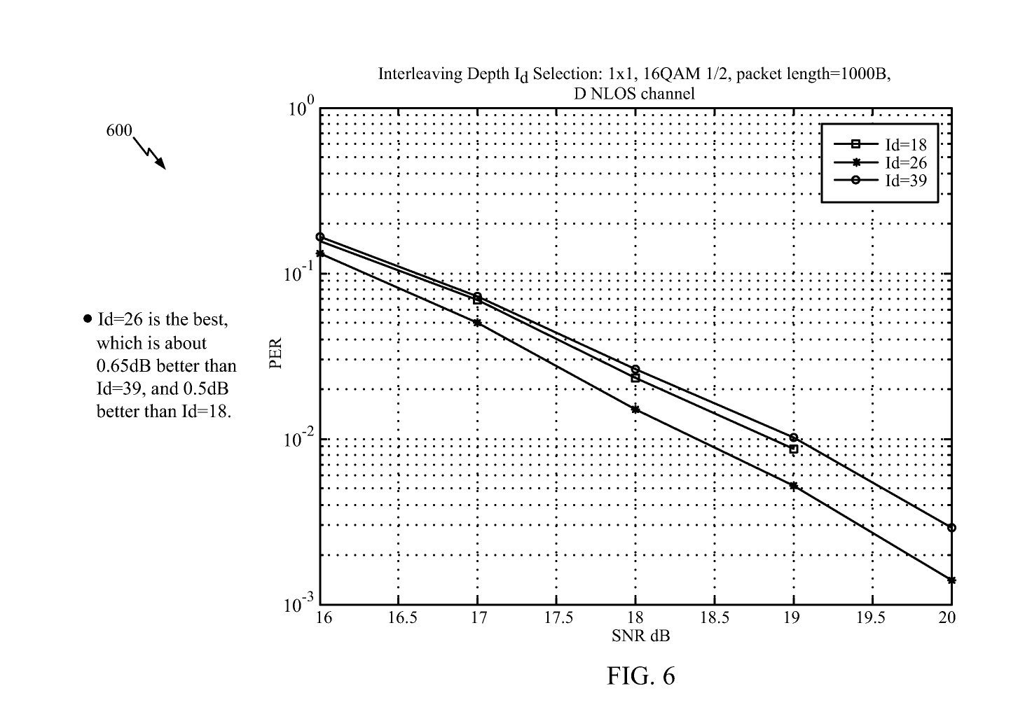

FIG. 6 is an example graph 600 of packet error rate (PER) versus signal-to-noise ratio (SNR) in decibels (dB) for three different interleaving depths on an 80 MHz D non-line-of-sight (NLOS) channel using a single spatial stream, 16-QAM (quadrature amplitude modulation with 16 modulation states), and a code rate of ½. The graph 600 shows that, for this particular combination of parameters, the SNR to achieve a 1% PER using an interleaving depth of 26 is about 0.65 dB better than an interleaving depth of 39 and about 0.5 dB better than an interleaving depth of 18. In other words, an interleaving depth of 26 may indicate using a lower transmission power to achieve the same PER when interleaving depths of 18 or 39 are used.

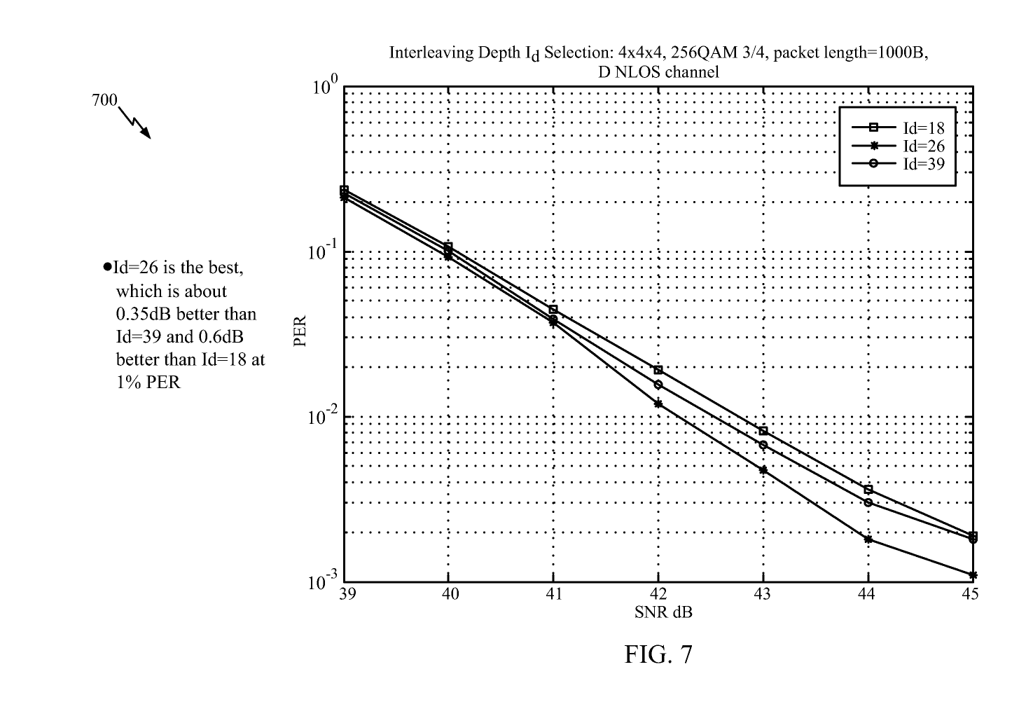

FIG. 7 is an example graph 700 of PER versus SNR in dB for three different interleaving depths on an 80 MHz D NLOS channel using four spatial streams, 256-QAM (QAM with 256 modulation states), and a code rate of ¾. The graph 700 indicates that, for this particular combination of parameters, the SNR to achieve a 1% PER using an interleaving depth of 26 is about 0.35 dB better than an interleaving depth of 39 and about 0.6 dB better than an interleaving depth of 18.

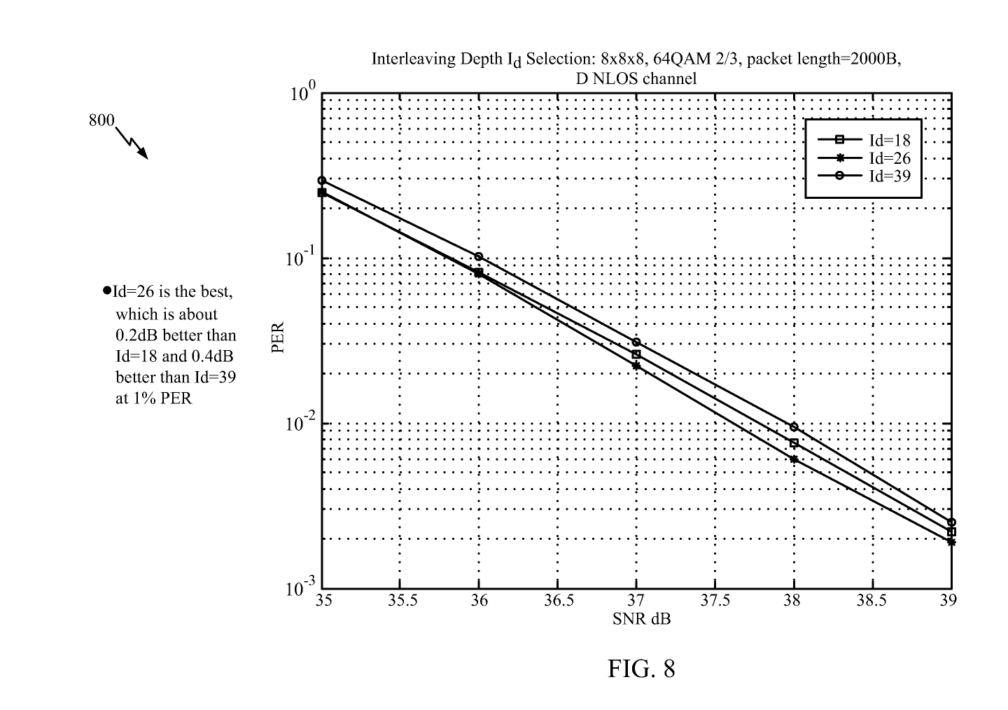

FIG. 8 is an example graph 800 of PER versus SNR in dB for three different interleaving depths on an 80 MHz D NLOS channel using eight spatial streams, 64-QAM (QAM with 64 modulation states), and a code rate of %. The graph 800 portrays that, for this particular combination of parameters, the SNR to achieve a 1% PER using an interleaving depth of 26 is about 0.4 dB better than an interleaving depth of 39 and about 0.2 dB better than an interleaving depth of 18.

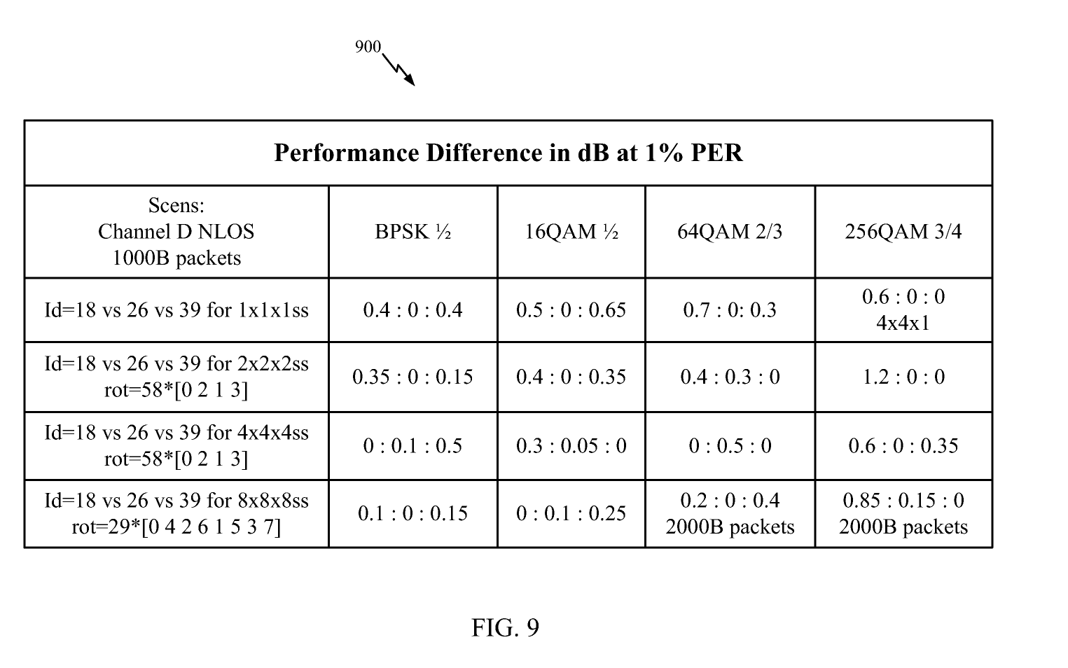

FIG. 9 is a table 900 comparing relative SNR differences at a PER of 1% achieved with three different interleaving depths for various modulation and coding schemes (MCSs) and for different numbers of spatial streams. The entries in the table 900 are in the form x:y:z for interleaving depths of 18, 26, and 39, respectively, where one of x, y, and z is 0 dB. For the entries that are not 0 dB, these interleaving depths yielded SNR simulation results that were x, y, or z decibels worse than the entry with 0 dB SNR at a 1% PER. The simulation results of FIGS. 6-8 are included in table 900.

From table 900, an interleaving depth of 26 involved the lowest SNR in the majority of MCS and spatial stream combinations. For those entries where another interleaving depth indicated a lower SNR than that with an interleaving depth of 26, the interleaving depth of 26 involves an SNR within 0.5 dB of the best performance. Therefore, for 80 MHz transmissions, an interleaving depth (I_{D}) of 26 may be indicated for use with all MCS and spatial stream combinations supported by IEEE 802.11ac, or a subsequent amendment to the IEEE 802.11 standard.

Furthermore, the possible base subcarrier rotation (D) during frequency interleaving may be 56, 58, or 60 for up to four spatial streams and 28, 29, or 30 for up to eight spatial streams. These numbers are based on a floored function of the number of data tones divided by the number of spatial streams (e.g., D=floor (234/8)=29 or D=floor (234/4)=58). Although using different D values may change the interleaving depth selection in some MCS cases, the best PER results may always be given by D=58 for four spatial streams and D=29 for eight spatial streams in all the cases studied. Accordingly, using an interleaving depth of 26 for all spatial stream and MCS combinations supported by IEEE 802.11ac (or a subsequent amendment to the IEEE 802.11 standard) may still represent a single viable solution. The entries in table 900 in FIG. 9 were simulated using D=58 for two and four spatial stream MCS combinations and using D=29 for eight spatial stream MCS combinations.

In cases with more than one spatial stream, the different spatial streams may each experience a different frequency rotation amount, including no frequency rotation, in the third stage of the interleaver 434. The subcarrier rotation (Dₙ) each spatial stream n experiences may be expressed as:

Dₙ=D*rot

where D is the base subcarrier rotation as described above and rot is a rotation index. For 80 MHz channels as shown in table 900 of FIG. 9, the rotation index may be [0 2 1 3] for the case of four spatial streams and [0 4 2 6 1 5 3 7] for the case of eight spatial streams. Therefore, for the case of four spatial streams where D=58, the first spatial stream may experience no frequency rotation (58*0=0), the second spatial stream may experience a rotation of 58*2=116 subcarriers (i.e., the base subcarrier rotation multiplied with the second element in the rotation index), the third spatial stream may experience a frequency rotation of 58*1=58 subcarriers, and the fourth spatial stream may experience a frequency rotation of 58*3=174 subcarriers. The frequency rotation may be accomplished in the interleaver 434 by a bit-reversal or a bit-circulation operation.

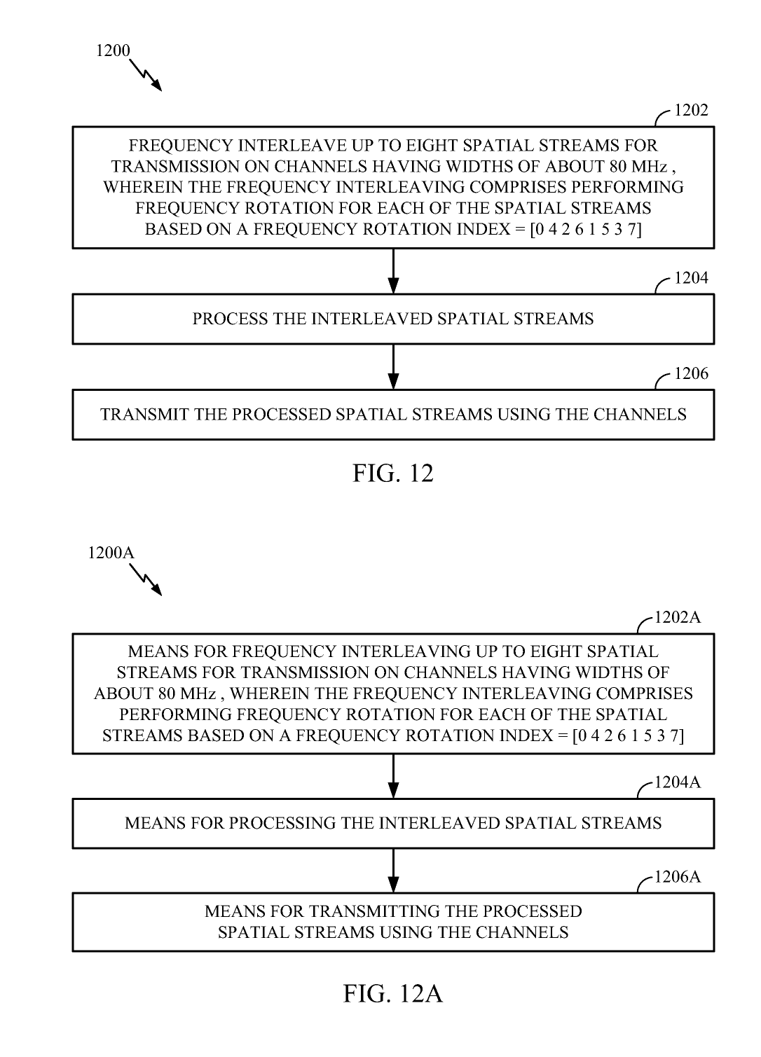

FIG. 12 illustrates example operations 1200 that may be performed at a transmitting entity, such as an AP or a user terminal, to frequency interleave spatial streams for transmissions on channels having widths of about 80 MHz. The operations 1200 may begin, at 1202, by frequency-interleaving up to eight spatial streams for transmission on channels having widths of about 80 MHz, wherein the frequency interleaving comprises performing frequency rotation for each of the spatial streams based on a frequency rotation index=[0 4 2 6 1 5 3 7]. For certain aspects, the frequency interleaving may also comprise using an interleaving depth of 26. The interleaving depth of 26 may be used for all MCSs supported by IEEE 802.11ac or a subsequent amendment to the IEEE 802.11 standard.

At 1204, the transmitting entity may process the interleaved spatial streams. This processing may include symbol mapping, performing an inverse Fourier transform to convert the mapped spatial streams to the time domain, converting the time domain streams to the analog domain using a digital-to-analog converter, and performing radio frequency (RF) processing on the analog signals (e.g., upconverting the baseband signals). At 1206, the transmitting entity may transmit the processed spatial streams via one or more antennas using the 80 MHz channels.

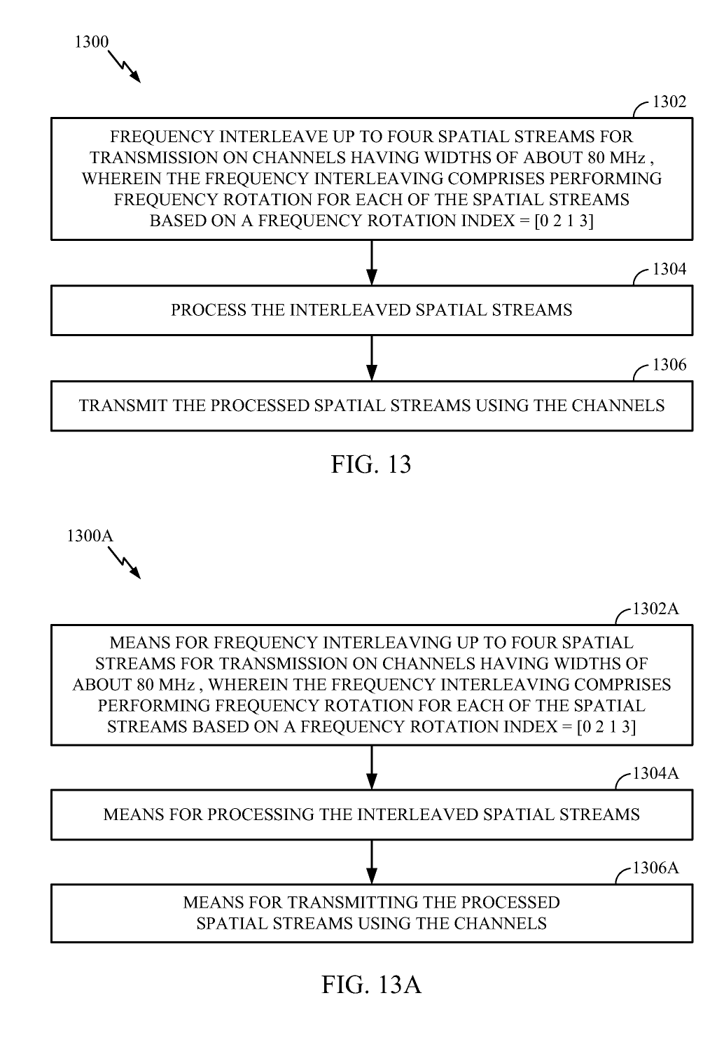

FIG. 13 illustrates example operations 1300 that may be performed at a transmitting entity, such as an AP or a user terminal, to frequency interleave spatial streams for transmissions on channels having widths of about 80 MHz. The operations 1300 may begin, at 1302, by frequency-interleaving up to four spatial streams for transmission on channels having widths of about 80 MHz, wherein the frequency interleaving comprises performing frequency rotation for each of the spatial streams based on a frequency rotation index=[0 2 1 3]. For certain aspects, the frequency interleaving may also comprise using an interleaving depth of 26. The interleaving depth of 26 may be used for all MCSs supported by IEEE 802.11ac or a subsequent amendment to the IEEE 802.11 standard.

At 1304, the transmitting entity may process the interleaved spatial streams. This processing may be similar to the processing at 1204 described above. At 1306, the transmitting entity may transmit the processed spatial streams via one or more antennas using the 80 MHz channels.

A receiving entity may perform reassembly of M received streams in a manner complementary to the parsing performed by the transmitting entity. The processing by the receiving entity is also dependent on, and complementary to, the processing performed by the transmitting entity.

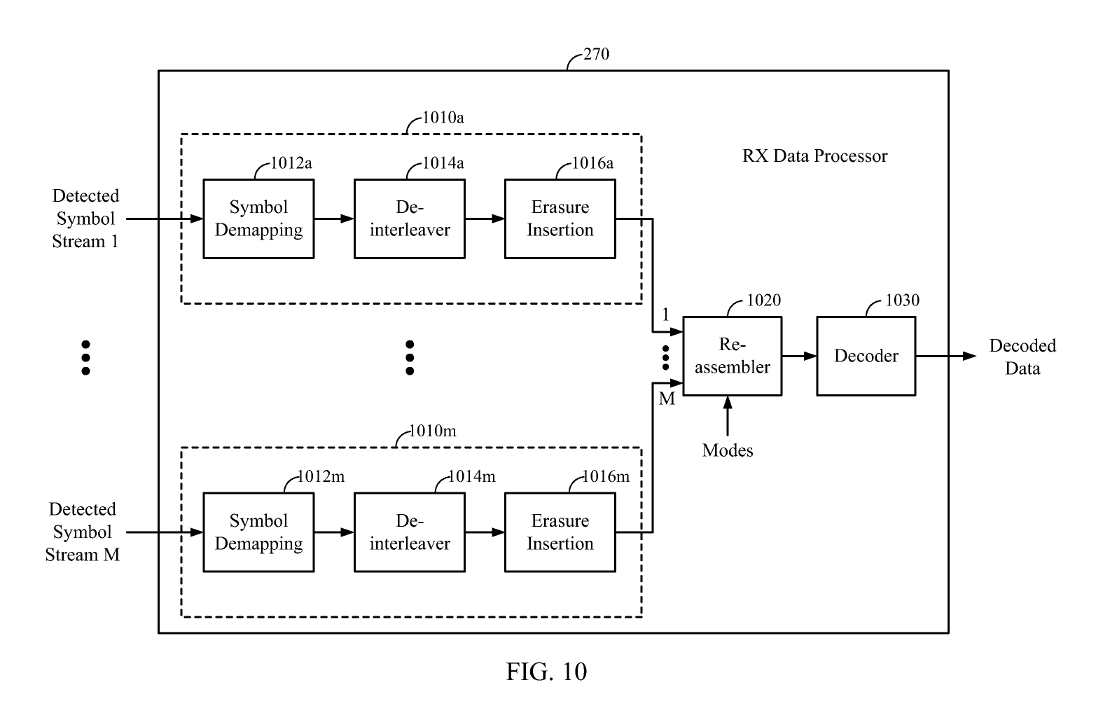

FIG. 10 is a block diagram of the RX data processor 270 at a receiving entity, such as the user terminal 120. Within RX data processor 270, M stream processors 1010a through 1010m are provided with M detected symbol streams from the RX spatial processor 260. Each stream processor 1010 may comprise a symbol demapping unit 1012, a de-interleaver 1014, and an erasure insertion unit 1016. The symbol demapping unit 1012 may generate log-likelihood ratios (LLRs) or some other representations for the code bits of the detected symbols. The LLR for each code bit indicates the likelihood of the code bit being a one (‘1’) or a zero (‘0’). The de-interleaver 1014 may de-interleave the LLRs for the code bits in a manner complementary to the interleaving performed by interleaver 434 at the transmitting entity. For example, the de-interleaver 1014 may perform reverse frequency rotation known as frequency de-rotation (e.g., bit de-circulation) in an effort to de-interleave the LLRs for the code bits. The erasure insertion unit 1016 may insert erasures for the code bits punctured by puncturing unit 432 at the transmitting entity. An erasure is an LLR value of 0 and indicates equal likelihood of a punctured code bit being a zero (‘0’) or a one (‘1’) since no information is known for the punctured code bit, which is not transmitted.

A reassembly unit 1020 may receive the outputs from M stream processors 1010a through 1010m for the M streams, reassemble or multiplex these outputs into one composite stream in a manner complementary to the parsing performed by the parser 420 at the transmitting entity, and provide the composite stream to a decoder 1030. The decoder 1030 may decode the LLRs in the composite stream in a manner complementary to the encoding performed by the encoder 410 at the transmitting entity and provide decoded data. The decoder 1030 may implement a Viterbi decoder if the encoder 410 is a convolutional encoder.

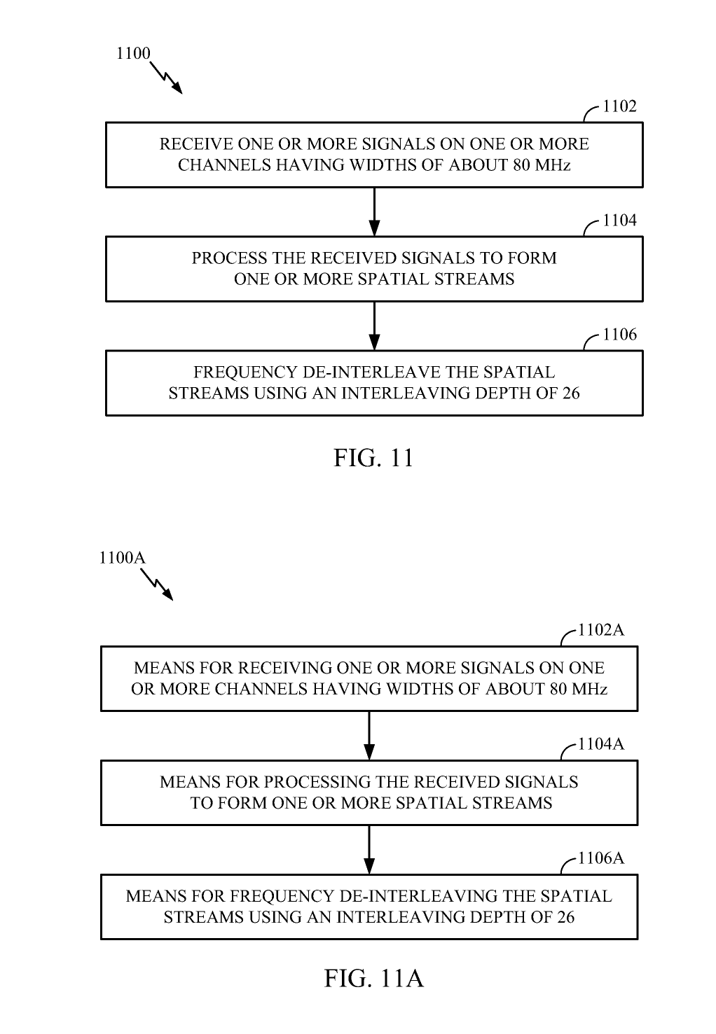

FIG. 11 illustrates example operations 1100 that may be performed at a receiving entity, such as a user terminal 120 or an access point 110, to frequency de-interleave spatial streams processed from signals received on channels having widths of about 80 MHz. The operations 1100 may begin, at 1102, by receiving one or more signals on one or more channels having widths of about 80 MHz, via one or more antennas.

At 1104, the receiving entity may process the received signals to form one or more spatial streams (also known as detected symbol streams). This processing may include RF processing on the received signals (e.g., downconverting to baseband signals), converting analog signals to digital signals using an analog-to-digital converter, performing a Fourier transform to convert the time domain digital signals to the frequency domain, and symbol demapping.

At 1106, the receiving entity may frequency de-interleave the spatial streams using an interleaving depth of 26. For certain aspects, the interleaving depth of 26 may be used for all MCSs supported by IEEE 802.11ac or a subsequent amendment to the IEEE 802.11 standard. For certain aspects, the interleaving depth of 26 may be used for all numbers of spatial streams supported by IEEE 802.11ac or a subsequent amendment.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in figures, those operations may have corresponding counterpart means-plus-function components with similar numbering. For example, operations 500 illustrated in FIG. 5 correspond to means 500A illustrated in FIG. 5A.

For example, means for transmitting may comprise a transmitter, such as the transmitter unit 222 of the access point 110 illustrated in FIG. 2, the transmitter unit 254 of the user terminal 120 depicted in FIG. 2, or the transmitter 310 of the wireless device 302 shown in FIG. 3. Means for receiving may comprise a receiver, such as the receiver unit 222 of the access point 110 illustrated in FIG. 2, the receiver unit 254 of the user terminal 120 depicted in FIG. 2, or the receiver 312 of the wireless device 302 shown in FIG. 3. Means for processing, means for frequency interleaving, means for encoding data, means for parsing, means for puncturing, means for inserting erasures, means for reassembling, and/or means for decoding may comprise a processing system, which may include one or more processors, such as the RX data processor 270, the RX spatial processor 260, the TX data processor 288, the TX spatial processor 290, and/or the controller 280 of the user terminal 120 or the RX data processor 242, the RX spatial processor 240, the TX data processor 210, the TX spatial processor 220, and/or the controller 230 of the access point 110 illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM, or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications, comprising:
frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to four spatial streams, and wherein a number of frequency rotations is 58;
processing the interleaved spatial streams; and
transmitting the processed spatial streams using the channels.

2. The method of claim 1, wherein the frequency interleaving comprises using the interleaving depth of 26 for all modulation and coding schemes (MCSs) supported by the Institute of Electrical and Electronics Engineers (IEEE) 802.11ac amendment or a subsequent amendment to the IEEE 802.11 standard.

3. The method of claim 1, wherein the frequency interleaving comprises using the interleaving depth of 26 for all numbers of the spatial streams supported by the Institute of Electrical and Electronics Engineers (IEEE) 802.11ac amendment or a subsequent amendment to the IEEE 802.11 standard.

4. The method of claim 1, wherein the frequency interleaving comprises using the interleaving depth of 26 for all code rates supported by the Institute of Electrical and Electronics Engineers (IEEE) 802.11ac amendment or a subsequent amendment to the IEEE 802.11 standard.

5. The method of claim 1, wherein the processing the interleaved spatial streams comprises symbol mapping the interleaved spatial streams using 256-QAM (quadrature amplitude modulation).

6. The method of claim 1, further comprising:
encoding data to generate coded bits;
parsing the coded bits to form the one or more spatial streams; and
puncturing the one or more spatial streams to achieve a code rate.

7. The method of claim 6, wherein the frequency interleaving comprises frequency interleaving the punctured spatial streams.

8. The method of claim 6, wherein the code rate comprises at least one of ½, ⅔, or ¾.

9. The method of claim 1, wherein each of the channels having widths of about 80 MHz comprises 234 tones.

10. An apparatus for wireless communications, comprising:
a processing system configured to:
frequency interleave one or more spatial streams for transmissions on one or more channels having widths of about 80 MHz, wherein the processing system is configured to frequency interleave the spatial streams by using an interleaving depth of 26 and performing frequency rotation, wherein the one or more spatial streams comprise up to four spatial streams, and wherein a number of frequency rotations is 58; and
process the interleaved spatial streams; and
a transmitter configured to transmit the processed spatial streams using the channels.

11. An apparatus for wireless communications, comprising:
means for frequency interleaving one or more spatial streams for transmissions on one or more channels having widths of about 80 MHz, wherein the means for frequency interleaving is configured to use an interleaving depth of 26 and to perform frequency rotation, wherein the one or more spatial streams comprise up to four spatial streams, and wherein a number of frequency rotations is 58;
means for processing the interleaved spatial streams; and
means for transmitting the processed spatial streams using the channels.

12. The apparatus of claim 11, wherein the means for frequency interleaving is configured to use the interleaving depth of 26 for all modulation and coding schemes (MCSs) supported by the Institute of Electrical and Electronics Engineers (IEEE) 802.11ac amendment or a subsequent amendment to the IEEE 802.11 standard.

13. The apparatus of claim 11, wherein the means for frequency interleaving is configured to use the interleaving depth of 26 for all numbers of the spatial streams supported by the Institute of Electrical and Electronics Engineers (IEEE) 802.11 ac amendment or a subsequent amendment to the IEEE 802.11 standard.

14. The apparatus of claim 11, wherein the means for frequency interleaving is configured to use the interleaving depth of 26 for all code rates supported by the Institute of Electrical and Electronics Engineers (IEEE) 802.11ac amendment or a subsequent amendment to the IEEE 802.11 standard.

15. The apparatus of claim 11, wherein the means for processing the interleaved spatial streams is configured to symbol map the interleaved spatial streams using 256-QAM (quadrature amplitude modulation).

16. The apparatus of claim 11, further comprising:
means for encoding data to generate coded bits;
means for parsing the coded bits to form the one or more spatial streams; and
means for puncturing the one or more spatial streams to achieve a code rate.

17. The apparatus of claim 16, wherein the means for frequency interleaving is configured to frequency interleave the punctured spatial streams.

18. The apparatus of claim 16, wherein the code rate comprises at least one of ½, or ¾.

19. The apparatus of claim 11, wherein each of the channels having widths of about 80 MHz comprises 234 tones.

20. A computer-program product for wireless communications, the computer-program product comprising:
a computer-readable medium comprising code for:
frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to four spatial streams, and wherein a number of frequency rotations is 58;
processing the interleaved spatial streams; and
transmitting the processed spatial streams using the channels.

21. A method for wireless communications, comprising:
frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to eight spatial streams, and wherein a number of frequency rotations is 29;
processing the interleaved spatial streams; and
transmitting the processed spatial streams using the channels.

22. The method of claim 21, wherein the frequency interleaving comprises using the interleaving depth of 26 for all modulation and coding schemes (MCSs) supported by the Institute of Electrical and Electronics Engineers (IEEE) 802.11ac amendment or a subsequent amendment to the IEEE 802.11 standard.

23. The method of claim 21, wherein the frequency interleaving comprises using the interleaving depth of 26 for all numbers of the spatial streams supported by the Institute of Electrical and Electronics Engineers (IEEE) 802.11ac amendment or a subsequent amendment to the IEEE 802.11 standard.

24. The method of claim 21, wherein the frequency interleaving comprises using the interleaving depth of 26 for all code rates supported by the Institute of Electrical and Electronics Engineers (IEEE) 802.11ac amendment or a subsequent amendment to the IEEE 802.11 standard.

25. The method of claim 29, wherein each of the channels having widths of about 80 MHz comprises 234 tones.

26. An apparatus for wireless communications, comprising:
a processing system configured to:
frequency interleave one or more spatial streams for transmissions on one or more channels having widths of about 80 MHz, wherein the processing system is configured to frequency interleave the spatial streams by using an interleaving depth of 26 and performing frequency rotation, wherein the one or more spatial streams comprise up to eight spatial streams, and wherein a number of frequency rotations is 29; and
processing the interleaved spatial streams; and
a transmitter configured to transmit the processed spatial streams using the channels.

27. An apparatus for wireless communications, comprising:
means for frequency interleaving one or more spatial streams for transmissions on one or more channels having widths of about 80 MHz, wherein the means for frequency interleaving is configured to use an interleaving depth of 26 and perform frequency rotation, wherein the one or more spatial streams comprise up to eight spatial streams, and wherein a number of frequency rotations is 29;
means for processing the interleaved spatial streams; and
means for transmitting the processed spatial streams using the channels.

28. The apparatus of claim 27, wherein the means for frequency interleaving is configured to use the interleaving depth of 26 for all modulation and coding schemes (MCSs) supported by the Institute of Electrical and Electronics Engineers (IEEE) 802.11ac amendment or a subsequent amendment to the IEEE 802.11 standard.

29. The apparatus of claim 27, wherein the means for frequency interleaving is configured to use the interleaving depth of 26 for all numbers of the spatial streams supported by the Institute of Electrical and Electronics Engineers (IEEE) 802.11 ac amendment or a subsequent amendment to the IEEE 802.11 standard.

30. The apparatus of claim 27, wherein the means for frequency interleaving is configured to use the interleaving depth of 26 for all code rates supported by the Institute of Electrical and Electronics Engineers (IEEE) 802.11ac amendment or a subsequent amendment to the IEEE 802.11 standard.

31. The apparatus of claim 27, wherein each of the channels having widths of about 80 MHz comprises 234 tones.

32. A computer-program product for wireless communications, the computer-program product comprising:
a computer-readable medium comprising code for:
frequency interleaving one or more spatial streams for transmissions on one or more channels having widths of about 80 MHz, wherein the frequency interleaving comprises using an interleaving depth of 26 and performing frequency rotation, wherein the one or more spatial streams comprise up to eight spatial streams, and wherein a number of frequency rotations is 29;
processing the interleaved spatial streams; and
transmitting the processed spatial streams using the channels.

33. A method for wireless communications, comprising:
receiving one or more signals on one or more channels having widths of about 80 MHz;
processing the received signals to form one or more spatial streams; and
frequency de-interleaving the spatial streams, wherein the frequency de-interleaving comprises using an interleaving depth of 26 and performing reverse frequency rotation, wherein the one or more spatial streams comprise up to four spatial streams, and wherein a number of reverse frequency rotations is 58.

34. The method of claim 33, wherein the frequency de-interleaving comprises using the interleaving depth of 26 for all modulation and coding schemes (MCSs) supported by the Institute of Electrical and Electronics Engineers (IEEE) 802.11ac amendment or a subsequent amendment to the IEEE 802.11 standard.

35. The method of claim 33, wherein the frequency de-interleaving comprises using the interleaving depth of 26 for all numbers of the spatial streams supported by the Institute of Electrical and Electronics Engineers (IEEE) 802.11ac amendment or a subsequent amendment to the IEEE 802.11 standard.

36. The method of claim 33, wherein the frequency de-interleaving comprises using the interleaving depth of 26 for all code rates supported by the Institute of Electrical and Electronics Engineers (IEEE) 802.11ac amendment or a subsequent amendment to the IEEE 802.11 standard.

37. The method of claim 33, wherein the processing the received signals comprises symbol demapping the spatial streams based on 256-QAM (quadrature amplitude modulation).

38. The method of claim 33, further comprising:
inserting erasures for punctured coded bits into the frequency de-interleaved spatial streams according to a code rate;
after the inserting, reassembling the spatial streams to form a composite stream; and
decoding the composite stream to generate decoded data.

39. The method of claim 38, wherein the code rate comprises at least one of ½, ⅔, or ¾.

40. The method of claim 33, wherein each of the channels having widths of about 80 MHz comprises 234 tones.

41. An apparatus for wireless communications, comprising:
a receiver configured to receive one or more signals on one or more channels having widths of about 80 MHz; and
a processing system configured to:
process the received signals to form one or more spatial streams; and
frequency de-interleave the spatial streams, wherein the processing system is configured to frequency de-interleave the spatial streams by using an interleaving depth of 26 and by performing reverse frequency rotation, wherein the one or more spatial streams comprise up to four spatial streams, and wherein a number of reverse frequency rotations is 58.

42. An apparatus for wireless communications, comprising:
means for receiving one or more signals on one or more channels having widths of about 80 MHz;
means for processing the received signals to form one or more spatial streams; and
means for frequency de-interleaving the spatial streams, wherein the means for frequency de-interleaving is configured to use an interleaving depth of 26 and to perform reverse frequency rotation, wherein the one or more spatial streams comprise up to four spatial streams, and wherein a number of reverse frequency rotations is 58.

43. The apparatus of claim 42, wherein the means for frequency de-interleaving is configured to use the interleaving depth of 26 for all modulation and coding schemes (MCSs) supported by the Institute of Electrical and Electronics Engineers (IEEE) 802.11ac amendment or a subsequent amendment to the IEEE 802.11 standard.

44. The apparatus of claim 42, wherein the means for frequency de-interleaving is configured to use the interleaving depth of 26 for all numbers of the spatial streams supported by the Institute of Electrical and Electronics Engineers (IEEE) 802.11 ac amendment or a subsequent amendment to the IEEE 802.11 standard.

45. The apparatus of claim 42, wherein the means for frequency de-interleaving is configured to use the interleaving depth of 26 for all code rates supported by the Institute of Electrical and Electronics Engineers (IEEE) 802.11ac amendment or a subsequent amendment to the IEEE 802.11 standard.

46. The apparatus of claim 42, wherein the means for processing the received signals is configured to symbol demap the spatial streams based on 256-QAM (quadrature amplitude modulation).

47. The apparatus of claim 42, further comprising:
means for inserting erasures for punctured coded bits into the frequency de-interleaved spatial streams according to a code rate;
means for reassembling the spatial streams to form a composite stream after the inserting; and
means for decoding the composite stream to generate decoded data.

48. The apparatus of claim 47, wherein the code rate comprises at least one of ½, ⅔, or ¾.

49. The apparatus of claim 42, wherein each of the channels having widths of about 80 MHz comprises 234 tones.

50. A computer-program product for wireless communications, the computer-program product comprising:
a computer-readable medium comprising code for:
receiving one or more signals on one or more channels having widths of about 80 MHz;
processing the received signals to form one or more spatial streams; and
frequency de-interleaving the spatial streams, wherein the frequency de-interleaving comprises using an interleaving depth of 26 and performing reverse frequency rotation, wherein the one or more spatial streams comprise up to four spatial streams, and wherein a number of reverse frequency rotations is 58.

51. A method for wireless communications, comprising:
receiving one or more signals on one or more channels having widths of about 80 MHz;
processing the received signals to form one or more spatial streams; and
frequency de-interleaving the spatial streams, wherein the frequency de-interleaving comprises using an interleaving depth of 26 and performing reverse frequency rotation, wherein the one or more spatial streams comprise up to eight spatial streams, and wherein a number of reverse frequency rotations is 29.

52. The method of claim 51, wherein the frequency de-interleaving comprises using the interleaving depth of 26 for all modulation and coding schemes (MCSs) supported by the Institute of Electrical and Electronics Engineers (IEEE) 802.11ac amendment or a subsequent amendment to the IEEE 802.11 standard.

53. The method of claim 51, wherein the frequency de-interleaving comprises using the interleaving depth of 26 for all numbers of the spatial streams supported by the Institute of Electrical and Electronics Engineers (IEEE) 802.11ac amendment or a subsequent amendment to the IEEE 802.11 standard.

54. The method of claim 51, wherein the frequency de-interleaving comprises using the interleaving depth of 26 for all code rates supported by the Institute of Electrical and Electronics Engineers (IEEE) 802.11ac amendment or a subsequent amendment to the IEEE 802.11 standard.

55. The method of claim 51, wherein each of the channels having widths of about 80 MHz comprises 234 tones.

56. An apparatus for wireless communications, comprising:
a receiver configured to receive one or more signals on one or more channels having widths of about 80 MHz; and
a processing system configured to:
process the received signals to form one or more spatial streams; and
frequency de-interleave the spatial streams, wherein the processing system is configured to frequency de-interleave the spatial streams by using an interleaving depth of 26 and performing reverse frequency rotation, wherein the one or more spatial streams comprise up to eight spatial streams, and wherein a number of reverse frequency rotations is 29.

57. An apparatus for wireless communications, comprising:
means for receiving one or more signals on one or more channels having widths of about 80 MHz;
means for processing the received signals to form one or more spatial streams; and
means for frequency de-interleaving the spatial streams, wherein the means for frequency de-interleaving is configured to use an interleaving depth of 26 and perform reverse frequency rotation, wherein the one or more spatial streams comprise up to eight spatial streams, and wherein a number of reverse frequency rotations is 29.

58. The apparatus of claim 57, wherein the means for frequency de-interleaving is configured to use the interleaving depth of 26 for all modulation and coding schemes (MCSs) supported by the Institute of Electrical and Electronics Engineers (IEEE) 802.11ac amendment or a subsequent amendment to the IEEE 802.11 standard.

59. The apparatus of claim 57, wherein the means for frequency de-interleaving is configured to use the interleaving depth of 26 for all numbers of the spatial streams supported by the Institute of Electrical and Electronics Engineers (IEEE) 802.11 ac amendment or a subsequent amendment to the IEEE 802.11 standard.

60. The apparatus of claim 57, wherein the means for frequency de-interleaving is configured to use the interleaving depth of 26 for all code rates supported by the Institute of Electrical and Electronics Engineers (IEEE) 802.11ac amendment or a subsequent amendment to the IEEE 802.11 standard.

61. The apparatus of claim 57, wherein each of the channels having widths of about 80 MHz comprises 234 tones.

62. A computer-program product for wireless communications, the computer-program product comprising:
a computer-readable medium comprising code for:
receiving one or more signals on one or more channels having widths of about 80 MHz;
processing the received signals to form one or more spatial streams; and
frequency de-interleaving the spatial streams, wherein the frequency de-interleaving comprises using an interleaving depth of 26 and performing reverse frequency rotation, wherein the one or more spatial streams comprise up to eight spatial streams, and wherein a number of reverse frequency rotations is 29.

63. A method for wireless communications, comprising:
frequency interleaving up to eight spatial streams for transmission on channels having widths of about 80 MHz, wherein the frequency interleaving comprises performing frequency rotation for each of the spatial streams based on a frequency rotation index=[0 4 2 6 1 5 3 7];
processing the interleaved spatial streams; and
transmitting the processed spatial streams using the channels.

64. The method of claim 63, wherein the frequency interleaving comprises using an interleaving depth of 26.

65. The method of claim 64, wherein the frequency interleaving comprises using the interleaving depth of 26 for all modulation and coding schemes (MCSs) supported by the Institute of Electrical and Electronics Engineers (IEEE) 802.11ac amendment or a subsequent amendment to the IEEE 802.11 standard.

66. The method of claim 63, wherein the performing frequency rotation comprises performing a bit-reversal operation for one of the spatial streams according to a base subcarrier rotation multiplied with an element in the frequency rotation index, the element corresponding to the one of the spatial streams.

67. The method of claim 66, wherein the base subcarrier rotation is 29.

68. The method of claim 63, wherein the processing the interleaved spatial streams comprises symbol mapping the interleaved spatial streams using 256-QAM (quadrature amplitude modulation).

69. The method of claim 63, further comprising:
encoding data to generate coded bits;
parsing the coded bits to form the spatial streams; and
puncturing the spatial streams to achieve a code rate.

70. The method of claim 69, wherein the frequency interleaving comprises frequency interleaving the punctured spatial streams.

71. The method of claim 69, wherein the code rate comprises at least one of ½, ⅔, or ¾.

72. The method of claim 63, wherein each of the channels having widths of about 80 MHz comprises 234 tones.

73. An apparatus for wireless communications, comprising:
a processing system configured to:
frequency interleave up to eight spatial streams for transmission on channels having widths of about 80 MHz, wherein the processing system is configured to frequency interleave the spatial streams by performing frequency rotation for each of the spatial streams based on a frequency rotation index=[0 4 2 6 1 5 3 7]; and
process the interleaved spatial streams; and
a transmitter configured to transmit the processed spatial streams using the channels.

74. An apparatus for wireless communications, comprising:
means for frequency interleaving up to eight spatial streams for transmission on channels having widths of about 80 MHz, wherein the means for frequency interleaving is configured to perform frequency rotation for each of the spatial streams based on a frequency rotation index=[0 4 2 6 1 5 3 7];
means for processing the interleaved spatial streams; and
means for transmitting the processed spatial streams using the channels.

75. The apparatus of claim 74, wherein the means for frequency interleaving is configured to use an interleaving depth of 26

76. The apparatus of claim 75, wherein the means for frequency interleaving is configured to use the interleaving depth of 26 for all modulation and coding schemes (MCSs) supported by the Institute of Electrical and Electronics Engineers (IEEE) 802.11ac amendment or a subsequent amendment to the IEEE 802.11 standard.

77. The apparatus of claim 74, wherein the means for frequency interleaving is configured to perform frequency rotation by performing a bit-reversal operation for one of the spatial streams according to a base subcarrier rotation multiplied with an element in the frequency rotation index, the element corresponding to the one of the spatial streams.

78. The apparatus of claim 77, wherein the base subcarrier rotation is 29.

79. The apparatus of claim 74, wherein the means for processing the interleaved spatial streams is configured to symbol map the interleaved spatial streams using 256-QAM (quadrature amplitude modulation).

80. The apparatus of claim 74, further comprising:
means for encoding data to generate coded bits;
means for parsing the coded bits to form the spatial streams; and
means for puncturing the spatial streams to achieve a code rate.

81. The apparatus of claim 80, wherein the means for frequency interleaving is configured to frequency interleave the punctured spatial streams.

82. The apparatus of claim 80, wherein the code rate comprises at least one of ½, ⅔, or ¾.

83. The apparatus of claim 74, wherein each of the channels having widths of about 80 MHz comprises 234 tones.

84. A computer-program product for wireless communications, the computer-program product comprising:
a computer-readable medium comprising code for:
frequency interleaving up to eight spatial streams for transmission on channels having widths of about 80 MHz, wherein the frequency interleaving comprises performing frequency rotation for each of the spatial streams based on a frequency rotation index=[0 4 2 6 1 5 3 7];
processing the interleaved spatial streams; and
transmitting the processed spatial streams using the channels.

85. A method for wireless communications, comprising:
frequency interleaving up to four spatial streams for transmission on channels having widths of about 80 MHz, wherein the frequency interleaving comprises performing frequency rotation for each of the spatial streams based on a frequency rotation index=[0 2 1 3];
processing the interleaved spatial streams; and
transmitting the processed spatial streams using the channels.

86. The method of claim 85, wherein the frequency interleaving comprises using an interleaving depth of 26.

87. The method of claim 86, wherein the frequency interleaving comprises using the interleaving depth of 26 for all modulation and coding schemes (MCSs) supported by the Institute of Electrical and Electronics Engineers (IEEE) 802.11ac amendment or a subsequent amendment to the IEEE 802.11 standard.

88. The method of claim 85, wherein the performing frequency rotation comprises performing a bit-reversal operation for one of the spatial streams according to a base subcarrier rotation multiplied with an element in the frequency rotation index, the element corresponding to the one of the spatial streams.

89. The method of claim 88, wherein the base subcarrier rotation is 58.

90. The method of claim 85, wherein the processing the interleaved spatial streams comprises symbol mapping the interleaved spatial streams using 256-QAM (quadrature amplitude modulation).

91. The method of claim 85, further comprising:
encoding data to generate coded bits;
parsing the coded bits to form the spatial streams; and
puncturing the spatial streams to achieve a code rate.

92. The method of claim 91, wherein the frequency interleaving comprises frequency interleaving the punctured spatial streams.

93. The method of claim 91, wherein the code rate comprises at least one of ½, ⅔, or ¾.

94. The method of claim 85, wherein each of the channels having widths of about 80 MHz comprises 234 tones.

95. An apparatus for wireless communications, comprising:
a processing system configured to:
frequency interleave up to four spatial streams for transmission on channels having widths of about 80 MHz, wherein the processing system is configured to frequency interleave the spatial streams by performing frequency rotation for each of the spatial streams based on a frequency rotation index=[0 2 1 3]; and
process the interleaved spatial streams; and
a transmitter configured to transmit the processed spatial streams using the channels.

96. An apparatus for wireless communications, comprising:
means for frequency interleaving up to four spatial streams for transmission on channels having widths of about 80 MHz, wherein the means for frequency interleaving is configured to perform frequency rotation for each of the spatial streams based on a frequency rotation index=[0 2 1 3];
means for processing the interleaved spatial streams; and
means for transmitting the processed spatial streams using the channels.

97. The apparatus of claim 96, wherein the means for frequency interleaving is configured to use an interleaving depth of 26.

98. The apparatus of claim 97, wherein the means for frequency interleaving is configured to use the interleaving depth of 26 for all modulation and coding schemes (MCSs) supported by the Institute of Electrical and Electronics Engineers (IEEE) 802.11ac amendment or a subsequent amendment to the IEEE 802.11 standard.

99. The apparatus of claim 96, wherein the means for frequency interleaving is configured to perform frequency rotation by performing a bit-reversal operation for one of the spatial streams according to a base subcarrier rotation multiplied with an element in the frequency rotation index, the element corresponding to the one of the spatial streams.

100. The apparatus of claim 99, wherein the base subcarrier rotation is 58.

101. The apparatus of claim 96, wherein the means for processing the interleaved spatial streams is configured to symbol map the interleaved spatial streams using 256-QAM (quadrature amplitude modulation).

102. The apparatus of claim 96, further comprising:
means for encoding data to generate coded bits;
means for parsing the coded bits to form the spatial streams; and
means for puncturing the spatial streams to achieve a code rate.

103. The apparatus of claim 102, wherein the means for frequency interleaving is configured to frequency interleave the punctured spatial streams.

104. The apparatus of claim 102, wherein the code rate comprises at least one of ½, ⅔, ¾.

105. The apparatus of claim 96, wherein each of the channels having widths of about 80 MHz comprises 234 tones.

106. A computer-program product for wireless communications, the computer-program product comprising:
a computer-readable medium comprising code for:
frequency interleaving up to four spatial streams for transmission on channels having widths of about 80 MHz, wherein the frequency interleaving comprises performing frequency rotation for each of the spatial streams based on a frequency rotation index=[0 2 1 3];
processing the interleaved spatial streams; and
transmitting the processed spatial streams using the channels.
